(19) United States
(12) Patent Application Publication
(10) Pub. No.: US 2012/0045273 A1
(43) Pub. Date: Feb. 23, 2012

(54) CONNECTING DEVICE

(75) Inventors: Peter Burtscher, Bludenz (AT); Lothar Saly, Burs (AT); Christian Loretz, Loruns (AT); Martin Dietrich, Rankweil (AT)

(73) Assignee: GETZNER WERKSTOFFE HOLDING GMBH, BURS/BLUDENZ (AT)

(21) Appl. No.: 13/265,264

(22) PCT Filed: Mar. 11, 2010
(86) PCT No.: PCT/AT10/00074

§ 371 Date: Oct. 19, 2011

(30) Foreign Application Priority Data
Apr. 28, 2009 (AT) A 642/2009

(51) Int. Cl. F16B 12/14; F16B 12/24

(52) U.S. Cl. 403/296; 403/292

(57) ABSTRACT

A connecting device for connecting at least two components (1, 2, 3), particularly floor or wall or ceiling elements, of a wooden structure to each other, particularly of a timber house, including at least one pin (4), a first fastening element (5, 5′, 5″) for fastening the pin (4) to one of the components (1, 2, 3), and a second fastening element (6, 6′) for fastening the pin (4) to another of the components (1, 2, 3), the pin (4) connecting the fastening elements (5, 5′, 5″, 6, 6′) to each other, and at least one intermediate layer (7) made of vibration-damping material being arranged on a side of at least one of the fastening elements (5, 5′, 5″, 6, 6′). Additionally, the pin (4) is also enveloped at least in some regions with at least one further intermediate layer (8) made of vibration-damping material.

### BACKGROUND

The present invention relates to a connecting device for connecting at least two components to one another, in particular floor elements or wall elements or ceiling elements, of a wooden structure, in particular a timber house, having at least one pin and a first fastening element for fastening the pin to one of the components and having a second fastening element for fastening the pin to another of the components, the pin connecting the fastening elements to one another, and at least one intermediate layer of vibration-damping material being situated on a side of at least one fastening element.

Connecting devices of the type indicated are used to connect heavier components of a wooden structure, in particular of a timber house, to one another in such a way that vibrations that occur at a location inside the wooden structure cannot be transmitted via the connecting device to other components of the wooden structure. Specifically, this has to do with, for example, preventing the transmission of footfall sounds and structure-borne sound in timber houses. Thus, the components that are to be connected to one another are in particular floor, wall, or ceiling elements of a timber house.

JP 2003-147 862 A shows a connection between a concrete base part and a precast reinforced concrete wall part using an anchor bolt that runs in a pipe filled with mortar in the foot part, such that the mortar has a vibration-damping effect. US 2008/0017780 A1 shows a housing for reducing transmission of energy that accommodates vibration-damping material and a disk that dampens vibration, both being fastened to a wall column by bolts.

A connecting device of the type under consideration is known from DE 199 32 589 C1, in particular FIG. 10 and the associated description. This device is a screw. The shaft of the screw forms the pin. The threading of the screw forms the first fastening element, and the screw head forms the second. In order to prevent propagation of vibrations or sound waves in the structure, this document proposes the situation of an intermediate layer of vibration-damping material on the screw head, i.e. on the second fastening element. The pin is mounted in the component in a bore having a somewhat larger diameter, so that an air gap results between the pin and one of the components.

In the structure shown in DE 199 32 589 C1, it was not recognized that due to the considerable load in such wooden structures due to settling processes, but also due to imprecision in assembly or pre-assembly, it can come about that the bolt is no longer situated in the exact center in the air gap, but rather lies against the components. This means that vibrations may be transmitted via the bolt.

### SUMMARY

The object of the present invention is to improve a connecting device of the type indicated in such a way that this can no longer happen.

According to the present invention, this is achieved in that in addition the pin is also sheathed in some areas with at least one additional intermediate layer of vibration-damping material.

According to the present invention, therefore, not just one intermediate layer is provided between the fastening element and the component, but rather in addition the pin is sheathed with a further intermediate layer of vibration-damping material. In this way, it can be achieved that the pin lies against at least one of the components preferably exclusively via the additional intermediate layer of vibration-damping material. The intermediate layer of vibration-damping material known from the prior art and additionally provided on the side of at least one of the fastening elements is advantageously situated, in the installed position, between the component and the fastening element, and prevents the transmission of vibrations at this location. In order to protect as much as possible against the transmission of vibration via the pin, it can be provided that the outer surface of the pin be completely sheathed, in the direction of its longitudinal extension and/or its circumference, by the additional intermediate layer of vibration-damping material. Depending on the design and the vibrations that are to be expected, however, this need not be necessary. In advantageous specific embodiments, however, it is at least provided that at least 20%, preferably at least 50%, of the outer surface of the pin is sheathed in the direction of its longitudinal extension and/or its circumference by the additional intermediate layer of vibration-damping material. The vibration-damping, or also vibration-insulating or sound-absorbing, material is advantageously an elastic material. This material preferably has a static modulus of elasticity between 0.025 N/m² and 5 N/m². This material is preferably an elastomer. It can for example preferably be foamed polyurethane elastomer or rubber elastomer or thermoplastic elastomer.

The first fastening element can be, as in the cited prior art, a threading situated on the pin, fashioned for penetration into wood. In alternative embodiments of the present invention, it is provided that the first fastening element is a mounting plate fastened to the pin, in particular fixed thereto. The pin can then be situated so that it is normal to an outer surface of the mounting plate. Preferably, the mounting plate has bores for fastening the mounting plate to one of the wooden elements, e.g. using screws. In an alternative specific embodiment, however, the first fastening element can also be a nut screwed onto a threading of the pin. The second fastening element is preferably formed by a nut screwed onto a threading of the pin or the like. However, this can also be a screw head situated fixedly on the pin, i.e. not movable relative to the pin.

A particularly preferred specific embodiment of the present invention provides that in order to tighten the connecting device, the distance between the fastening elements is adjustable, in particular in the direction of a longitudinal extension of the pin. This solution suggests itself in particular in the case of heavy wood structures such as timber houses, and enables both a tightening and a retightening of the connecting device if, due to an increased load, or due to settling or other movements in the wood, the distance originally present between the fastening elements no longer results in secure or play-free holding of the components that are to be connected to one another. By changing the distance between the fastening elements, the connecting device can be retightened. Here, “adjustable” is to be understood in particular as meaning that distances differing from one another can be set, and the modified or set distances are then maintained by frictional forces or the like.

The pin, the fastening elements, and the insert elements that may also be present are advantageously harder than the vibration-damping material or materials. Preferably, the pin and the fastening element, and also if warranted the insert elements, are made of metal, preferably steel or aluminum, or at least include such metals. In particular for the construction of a timber house, the pins advantageously have a diameter between 10 and 30 mm, preferably between 16 and 24 mm. Depending on their type, their length is preferably between 12 cm and 80 cm. In wooden structures, in particular timber houses, in which at least two components, in particular made of wood, are connected to one another by at least one connecting device according to the present invention, in which the first fastening element is supported on or fastened to one of the components and the second fastening element is supported on or fastened to another of the components, it is advantageously provided that for at least one of the components the pin and the fastening element supported on or fastened to this component are connected to this component exclusively with interposition of the intermediate layer of vibration-damping material and the additional intermediate layer. For reasons of visual appeal, but also for static reasons, it is often advantageous if the pin and the fastening elements, preferably at least in the fully assembled state, are situated completely inside bores and/or milled-out parts made in the components of the wooden structure. In order not only to suppress transmission of sound or vibrations via the connecting device, but to completely eliminate such transmission, it is advantageously provided that the components of the wooden structure are connected to one another exclusively with interposition of vibration-damping materials. Here, the same vibration-damping materials can be used that are used in the intermediate layer and the additional intermediate layer.

Connecting devices according to the present invention are provided in particular in order to connect wall elements and ceiling elements or floor elements of timber houses to one another. Here it can be provided that a connecting device connects two components to one another, such as a wall element and a ceiling element, or a wall element and a floor element. However, it can also be provided that connecting devices according to the present invention are designed to connect two wall elements situated one over the other and a ceiling element situated between them. Thus, it is in no way to be assumed that connecting devices are necessarily provided only for connecting two components to one another. They may also be designed so as to fasten three or more components to one another.

### BRIEF DESCRIPTION OF THE DRAWINGS

Further features and details of exemplary embodiments according to the present invention result from the following description of the Figures.

FIGS. 1 and 2 show a first exemplary embodiment according to the present invention of a connecting device;

FIGS. 3 and 4 show a second exemplary embodiment according to the present invention in which various components are connected to one another;

FIG. 5 shows a third exemplary embodiment according to the present invention;

FIGS. 6 and 7 show a fourth exemplary embodiment according to the present invention;

FIG. 8 shows a fifth exemplary embodiment according to the present invention;

FIGS. 9 and 10 show a sixth exemplary embodiment according to the present invention;

FIGS. 11 and 12 show a seventh exemplary embodiment according to the present invention.

### DETAILED DESCRIPTION OF THE PREFERRED EMBODIMENTS

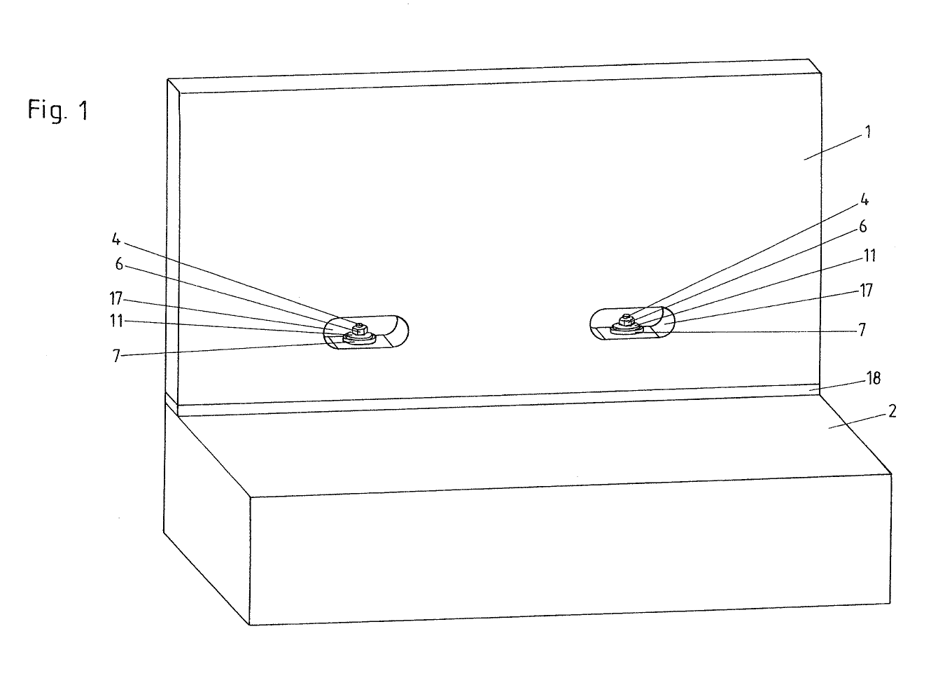

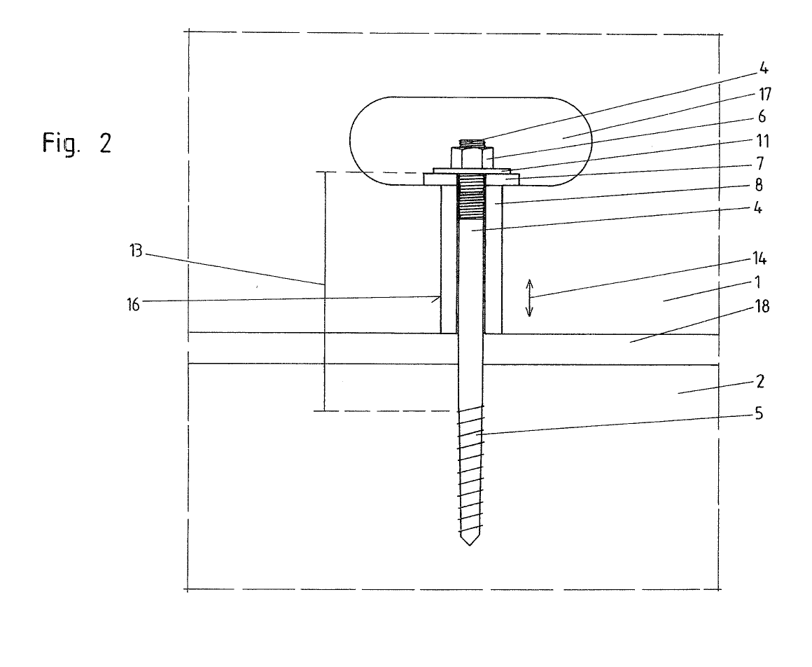

FIG. 1 shows the situation in which an exemplary embodiment according to the present invention of a connecting device is used to connect two components 1 and 2 of a timber house to one another. Component 1 is a wall element of a timber house, and component 2 is a floor element. In the depicted, fully assembled state, pin 4 and the fastening elements are situated completely inside the components, partly in bores 16 not shown in FIG. 1 and partly in milled-out parts 17 visible in FIG. 1. A separating layer 18 of vibration-damping material is situated between the two components 1 and 2 in a known manner so that vibrations and sound cannot be transmitted directly between the two components 1 and 2. In order also to eliminate transmission of vibrations or sound via the connecting device, according to the present invention this device is fashioned in the manner shown in particular in the sectional representation shown in FIG. 2. There, first of all pin 4 can be seen. This pin has a respective fastening element 5 or 6 on each of its opposite sides. In this exemplary embodiment, first fastening element 5 is realized as a threading situated on pin 4 and fashioned for penetration into wood. As the second fastening element 6, in this first exemplary embodiment a nut is provided that is screwed onto a threading of the pin. By rotating the nut, or second fastening element 6, a distance 13 between the fastening elements 5 and 6 can be adjusted in the direction of longitudinal extension 14 of the pin 4. This makes it possible to tighten the connecting device during initial assembly. However, it also enables a retightening of the connecting device if the distance between a milled-out part 17 and the second component 2 has changed, e.g. due to increased load or due to shrinkage of the wood or due to settling. Access to the second fastening element 6 is permanently provided by the milled-out part 17. Otherwise, the connecting device is concealed in the components 1 and 2, so that its presence is not visually disturbing.

The second fastening element 6, or the nut, is supported via an insert element 11—here a washer—on the intermediate layer 7, which in turn lies against the corresponding shoulders of the milled-out part 17. The intermediate layer 7 made of vibration-damping material eliminates transmission of vibrations or sound via the second fastening element 6. In order to prevent the pin 4 from coming into direct contact with the walls of the bore 16 of the component 1 as a result of settling, imprecision during assembly, or some other bending or seizing of the structure, according to the present invention it is additionally provided that the pin 4 is sheathed by an additional intermediate layer 8 of vibration-damping material. In the depicted exemplary embodiment, the additional intermediate layer 8 is fashioned in the form of a pipe. The pin 4 is mounted in the central hollow space of this pipe. In the depicted first exemplary embodiment according to FIGS. 1 and 2, additional intermediate layer 8 extends over the entire length of bore 16 in the component 1, and also over more than 20% of the length of pin 4. Advantageously, however, it is provided that the pin 4 lies against at least one of the components 1 or 2 exclusively via the intermediate layers 7 and 8, in order in this way to eliminate transmission of sound between the two components 1 and 2 via the connecting device.

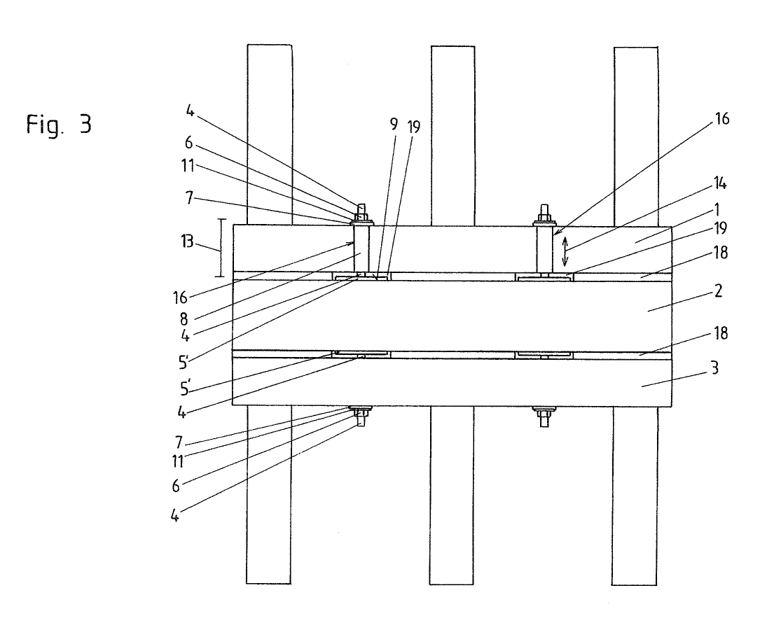

In the first exemplary embodiment according to FIGS. 1 and 2, the component 1 is a solid wood wall, so that the bore 16 and the upwardly open milled-out part 17 must be provided in order to accommodate the connecting device in the component 1. FIG. 3 shows another specific embodiment according to the present invention of a connecting device. In addition, differing from the first exemplary embodiment, the wall elements 1 and 3 are not massive, but are realized in a column construction, so that a milled-out part 17 does not have to be provided in order to provide access to the second fastening element 6. FIG. 3 shows a lateral view of a sequence of an upper wall element 1, a ceiling element 2, and a lower wall element 3, in which these components 1 through 3 are again connected to one another by the connecting devices according to the present invention.

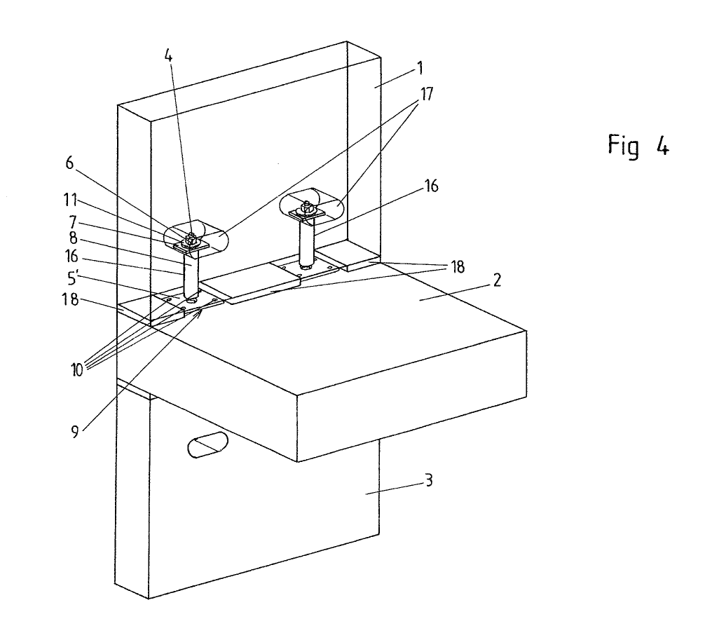

The specific construction shown here of the connecting device provides as the first fastening element 5′ a mounting plate that is fastened to the pin 4 for example by welding. The pin 4 has a normal orientation to an outer surface 9 of the mounting plate 5′. As can be seen in particular in FIG. 4, the mounting plate has bores 10 by which the mounting plate, and therewith the overall connecting device, can be fastened to the component 2. This fastening can be accomplished by a screwed connection, but also by some other variant fastening such as gluing or the like. In the depicted exemplary embodiment according to FIGS. 3 and 4, the mounting plates 5′ are however situated in openings 19 in a separating layer 18 of vibration-damping material. Apart from the realization of first fastening element 5′ as a mounting plate, the connecting device is otherwise fashioned as in the first exemplary embodiment shown in FIGS. 1 and 2, so that further explanation is not required here.

FIG. 4 shows how the specific embodiment already shown in FIG. 3 of a connecting device according to the present invention can also be used to fasten wall elements 1 and 3 having a massive construction to ceiling elements 2. For this purpose, corresponding milled-out parts 17 and bores 16 must again be provided in the wall elements 1.

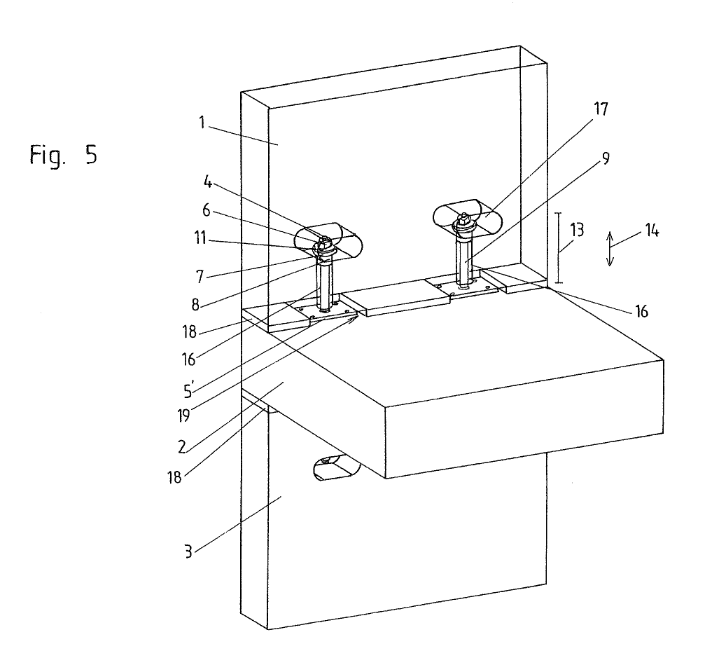

FIG. 5 shows another variant that for the most part corresponds to the connecting device according to FIG. 4; however, differing from the variant according to FIG. 4, in FIG. 5 the additional intermediate layer 8 of vibration-damping material is made shorter. This variant provides an example illustrating that the second intermediate layer 8 need not necessarily extend over the entire length of the bore 16. The length, or size, of the second intermediate layer 8 should however be selected such that even given the maximum deformations that are to be expected it is still ensured that the pin 4 does not lie directly against the respective component 1 or 3. Differing from the exemplary embodiment shown in FIG. 5, it also need not necessarily provided that the additional intermediate layer 8 is situated directly underneath or adjacent to the intermediate layer 7. Advantageously, in the shortened construction the additional intermediate layer 8 is to be situated wherever there is a danger that the pin 4 could come to lie against the inner wall of bore 16, or directly against the components 1 or 2.

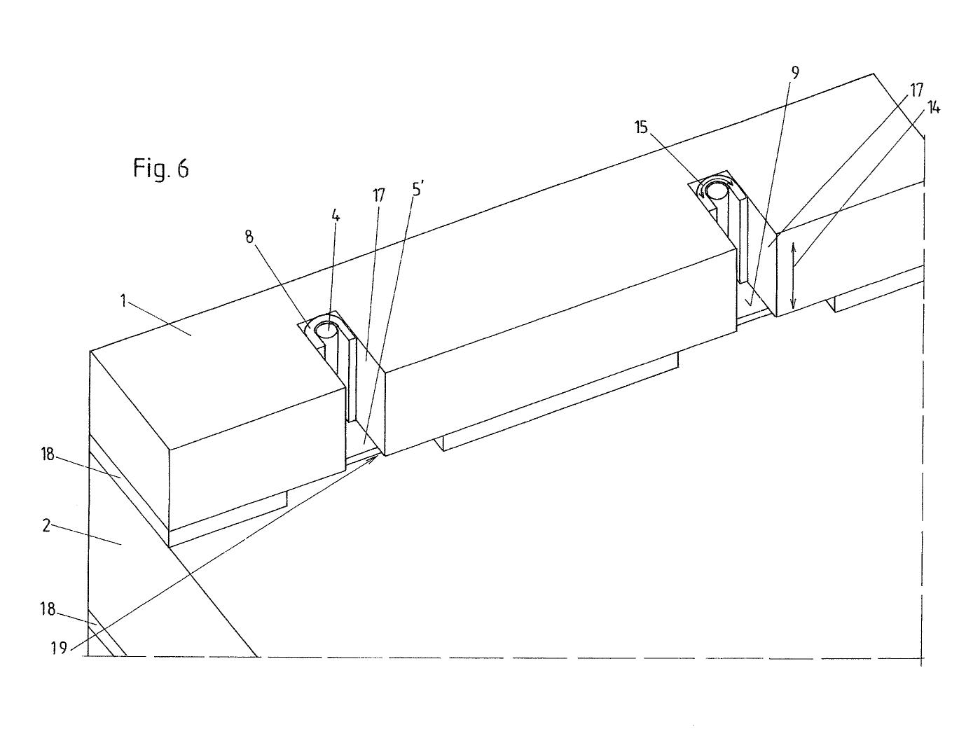

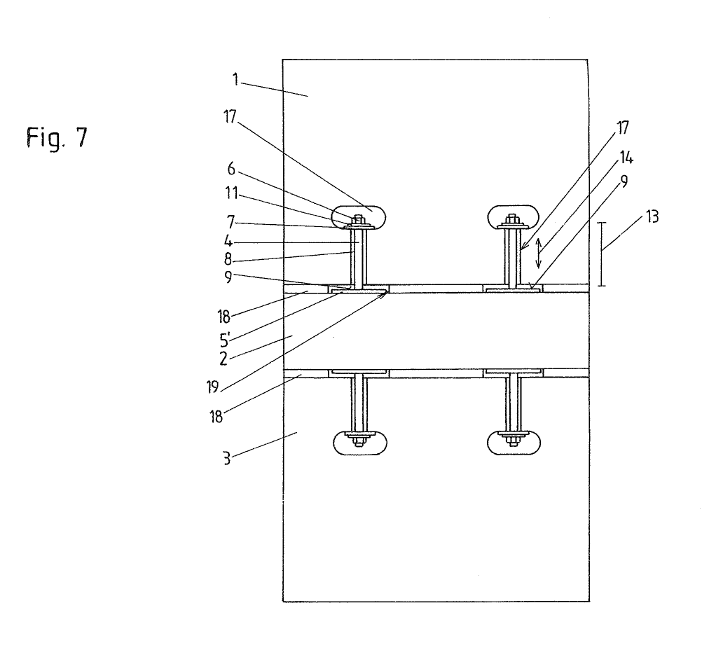

While in the exemplary embodiments discussed above the outer surface of the pin 4 is always completely sheathed in the direction of circumference 15 of pin 4 by additional intermediate layer 8 made of vibration-damping material, FIGS. 6 and 7 show a variant realization of the present invention in which this is not a case. As can be seen in particular in the partly sectional representation shown in FIG. 6, in this specific embodiment the milled-out parts 17 are provided in component 1 in place of the otherwise present bores 16. In this way, it is not necessary to completely sheath the pins 4 in a circumferential direction 15. As can be seen in particular in the sectional representation shown in FIG. 6, the additional intermediate layer 8 of vibration-damping material that is used here sheaths the pin 4 in circumferential direction 15 only to an extent of about 50%. For completeness, here it is to be noted that in the partially sectional representation shown in FIG. 6, the components of the connecting device shown in FIG. 7 situated above the additional intermediate layer 8 have been omitted.

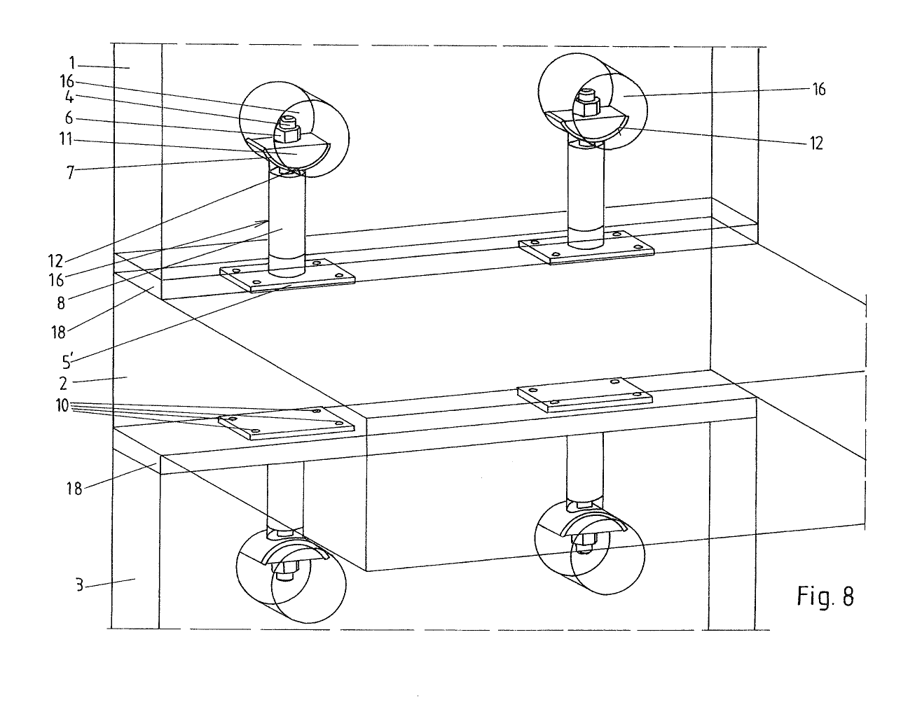

In the specific embodiments discussed above according to FIGS. 1 through 7, in each case the milled-out parts 17 were provided as necessary in order to realize accessibility to the second fastening element 6. FIG. 8 now shows a variant in which the milled-out parts 17 have been replaced by bores 16. This does not necessitate any change to the basic design of the connecting device. This basic design corresponds extensively to the exemplary embodiment shown in FIGS. 3 and 4. Only the differences therefrom are discussed below. A first difference is to be found in the constructive shape of the insert element 11 with which the second fastening element 6 is supported against the inner walls of the bore 16. In order to match the shape or contour of these inner walls of the bores 16, the support surfaces 12 of the insert element 11 on which the intermediate layers 7 of vibration-damping material are situated are each made as circularly round segments, whereas the support surfaces 12 are made flat in the previously depicted embodiments. For the sake of completeness, here it is to be noted that of course it is possible for support surface 12 to have only a shape whose rounding is not that of a circular segment; its rounding may have some other shape. In addition, it is to be noted that as long as the connecting device has not yet been tightened, the insert element 11 can be mounted displaceably on the pin 4, as is known from the case of normal washers.

A second difference from the exemplary embodiment according to FIGS. 3 and 4 is that the openings 19 in the separating layer 18 have been omitted. The exemplary embodiment according to FIG. 8 shows that it can also be sufficient to provide corresponding holes in the separating layer 18 through which the pin 4, and if warranted also the additional intermediate layer 8, can be guided.

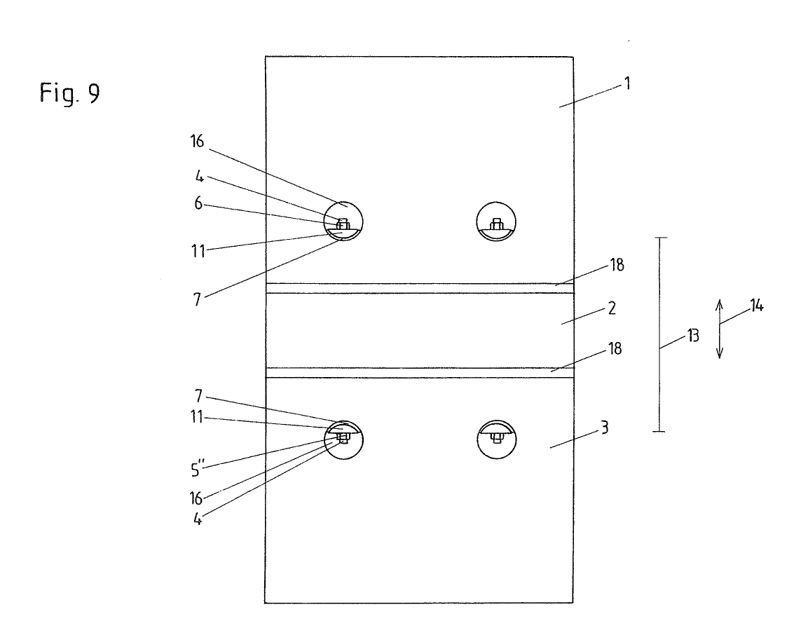

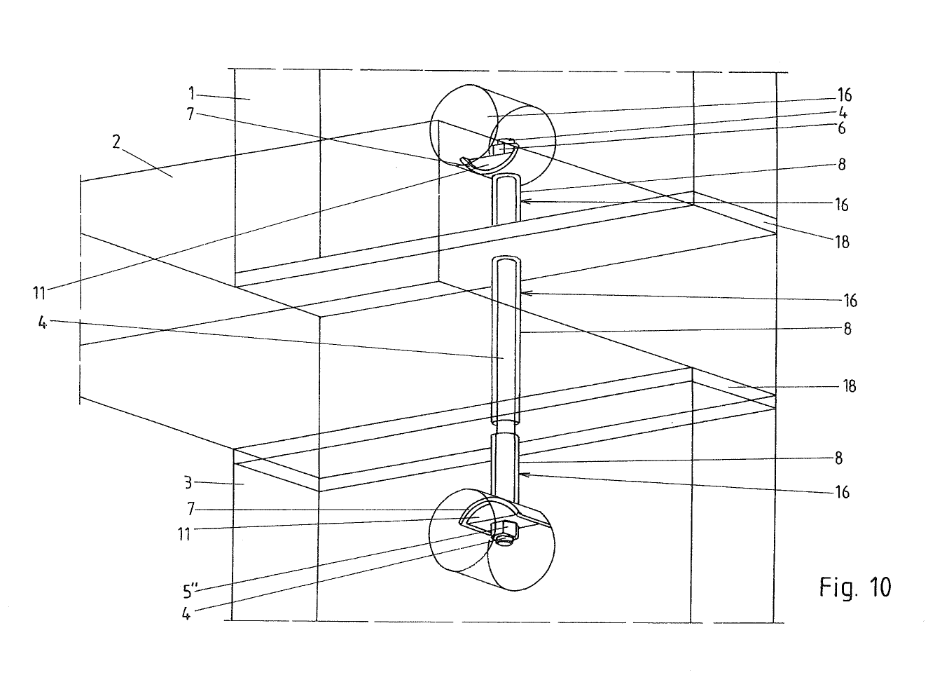

While the specific embodiments discussed above of connecting devices according to the present invention have in each case been provided in order to connect two components 1, 2, or 3 to one another, FIGS. 9 and 10 show an embodiment of the present invention in which a single connecting device can be used to connect the three components 1, 2, and 3—here again a wall element 1, a ceiling element 2, and another wall element 3—to one another.

In order to realize this, in this exemplary embodiment the first fastening element 5″, like the second fastening element 6, is fashioned as a nut screwed onto a threading of pin 4. The shape of the insert element 11 corresponds to that shown in the exemplary embodiment according to FIG. 8. As is shown in particular in the transparent representation of FIG. 10, in the exemplary embodiment under consideration here the connecting device has a single continuous pin for connecting the three components 1, 2, 3. The first and second fastening elements 5″ and 6 are each accessible via the bores 16. The pin 4 is guided in additional bores 16 in the components 1, 2, and 3. In the depicted exemplary embodiment, the additional intermediate layer 8 extends over almost the entire distance 13 in the longitudinal direction 14 of the pin 4. A retightening of the connecting device is possible in this exemplary embodiment both via the first fastening element 5″ and via the second fastening element 6.

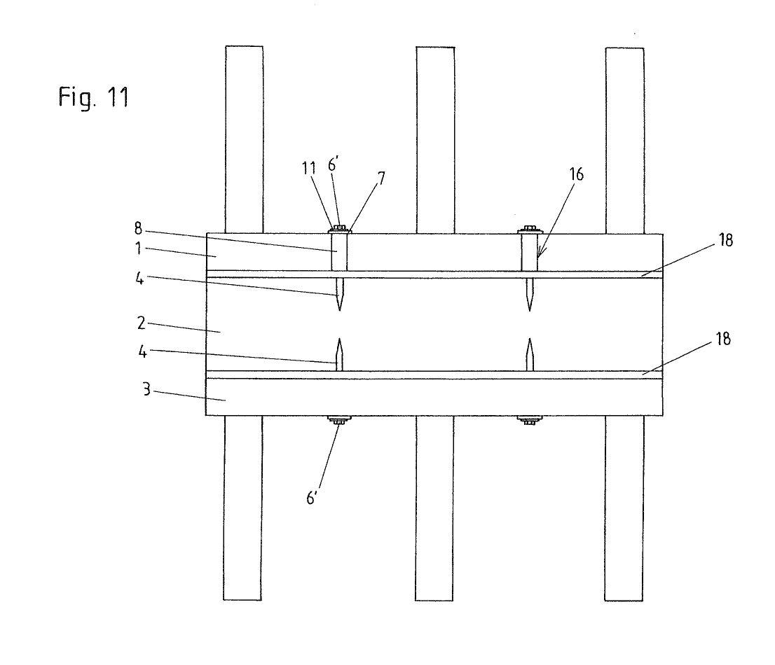

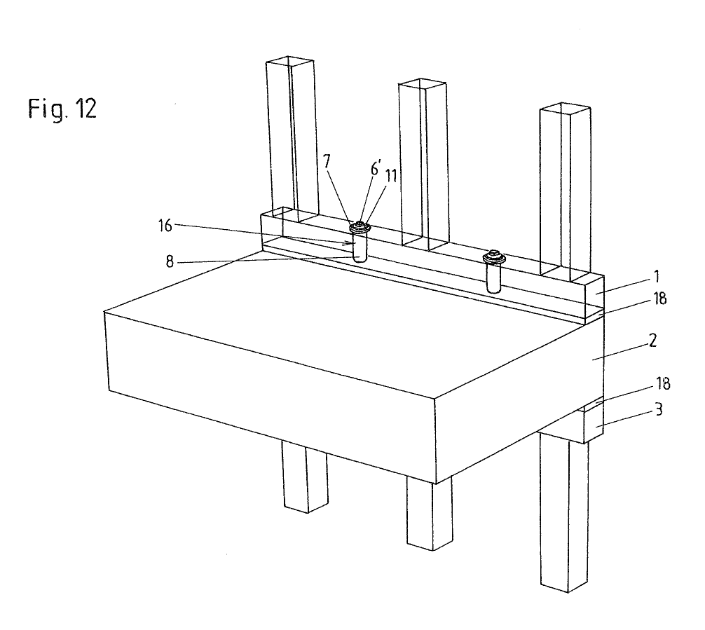

In its broad features, the further exemplary embodiment according to FIGS. 11 and 12 corresponds to the first exemplary embodiment according to FIGS. 1 and 2. However, here, as the second fastening element 6′ there is provided not a nut screwed onto a threading of the pin 4, but rather a screw head fixed on the pin 4. This means that in this exemplary embodiment according to FIGS. 11 and 12, the distance 13 between the fastening elements 5 and 6′ cannot be adjusted in order to retighten the connecting device, because both the screw head 6′ and the threading (not shown in FIG. 11, but fashioned as in FIGS. 1 and 2) of the first fastening element 5 are situated fixedly on the pin 4. This specific embodiment is therefore in particular in cases in which retightening can be omitted.

In a specific embodiment that is not shown, it would also be conceivable to provide a second fastening element 6′ on the pin 4 in the form of a fixed screw head and, in order to provide the possibility of tightening, to mount the other end of the pin 4 in a threaded sleeve of a mounting plate 5′ (also not shown). In such an embodiment, it would then be possible to rotate the pin 4 so as to move it inward and outward in the named threaded sleeve, in order in this way to adjust the distance between the fastening elements realized as the screw head and the mounting plate.

As will be apparent from the large number of explicitly depicted specific embodiments of the present invention, this invention is not limited to the particular variants shown. Individual features of the various depicted and described exemplary embodiments can also be combined with one another in other ways. The depicted examples are provided only for the purpose of explanation.

Legend of Reference Characters
1 component
2 component
3 component
4 pin
5, 5′, 5″ first fastening element
6, 6′ second fastening element
7 intermediate layer
8 additional intermediate layer
9 outer surface
10 bore
11 insert element
12 support surface
13 distance
14 longitudinal extension
15 circumferential direction
16 bore
17 milled-out part
18 separating layer
19 opening

1. A connecting device for connecting at least two components (1, 2, 3) to one another, comprising at least one pin (4) and a first fastening element (5, 5′, 5″) for fastening the pin (4) to one of the components (1, 2, 3) and having a second fastening element (6, 6′) for fastening the pin (4) to another of the components (1, 2, 3), the pin (4) connecting the fastening elements (5, 5′, 5″, 6, 6″) to one another, and at least one intermediate layer (7) of vibration-damping material being situated on a side of at least one of the fastening elements (5, 5′, 5″, 6, 6′), and the pin (4) is sheathed at least in some regions with at least one additional intermediate layer (8) of vibration-damping material.

2. The connecting device as recited in claim 1, wherein the first fastening element (5) is a threading that is situated on the pin (4) and is adapted for penetration into wood.

3. The connecting device as recited in claim 1, wherein the first fastening element (5′) is a mounting plate fastened on the pin.

4. The connecting device as recited in claim 3, wherein the pin (4) has a normal orientation to an outer surface (9) of the mounting plate, and Worn the mounting plate has bores (10) for fastening the mounting plate to one of the two components (1, 2, 3).

5. The connecting device as recited in claim 1, wherein the first fastening element (5″) is a nut screwed onto a threading of the pin.

6. The connecting device as recited in claim 1, wherein the second fastening element (6, 6′) is a nut screwed onto a threading of the pin (4) or is a screw head fixed on the pin (4).

7. The connecting device as recited in claim 6, wherein at least one insert element (11) having a support surface (12) facing away from the nut or from the screw head is situated on the pin (4) in order to support at least one of the nut or the screw head, such that at least in a mounted position the intermediate layer (7) of the vibration-damping material is situated on the support surface (12).

8. The connecting device as recited in claim 7, wherein the support surface (12) is fashioned flat or is round at least in segments.

9. The connecting device as recited in claim 1, wherein in order to tighten the connecting device a distance (13) between the fastening elements (5, 5′, 5″, 6, 6′) is adjustable in a direction of a longitudinal extension (14) of the pin (4).

10. The connecting device as recited in claim 1, wherein an outer surface of the pin (4) is sheathed by the additional intermediate layer (8) of vibration-damping material, in at least one of a direction of a longitudinal extension (14) of the pin (4) or of a circumference (15) of the pin (4), to an extent of at least 20%.

11. The connecting device as recited in claim 1, wherein the pin (4) and the fastening elements (5, 5′, 5″, 6, 6′) comprise metal.

12. The connecting device as recited in claim 1, wherein the pin (4) has a diameter between 10 mm and 30 mm.

13. A wooden structure in which at least two components (1, 2, 3) made of wood are connected to one another by at least one connecting device as recited in claim 1, wherein the first fastening element (5, 5′, 5″) is supported on or is fastened to one of the components (1, 2, 3) and the second fastening element (6, 6′) is supported on or fastened to another of the components (1, 2, 3), and for at least one of the components (1, 2, 3) the pin (4) and the fastening element (5, 5′, 5″, 6, 6′) supported on or fastened to said component (1, 2, 3) are connected to said component (1, 2, 3) exclusively with interposition of the intermediate layer (7) of vibration-damping material and the additional intermediate layer (8) of vibration-damping material.

14. The wooden structure as recited in claim 13, the pin (4) and the fastening elements (5, 5′, 5″, 6, 6′) are situated completely inside at least one of bores (16) or milled-out parts (17) in the components (1, 2, 3) of the wooden structure.

15. The wooden structure as recited in claim 13, wherein the components (1, 2, 3) of the wooden structure are connected to one another exclusively with interposition of the vibration-damping material.

16. The connecting device as recited in claim 1, wherein the pin (4) and the fastening elements (5, 5′, 5″, 6, 6′) are harder than the vibration-damping material(s).
